(19) United States
(12) Patent Application Publication
(10) Pub. No.: US 2026/0154015 A1
(43) Pub. Date: Jun. 4, 2026

(54) COMMUNICATION DEVICE, SERVER, NON-TRANSITORY COMPUTER-READABLE RECORDING MEDIUM STORING COMPUTER-READABLE INSTRUCTIONS FOR COMMUNICATION DEVICE, NON-TRANSITORY COMPUTER-READABLE RECORDING MEDIUM STORING COMPUTER-READABLE INSTRUCTIONS FOR SERVER, AND COMMUNICATION SYSTEM

(71) Applicant: BROTHER KOGYO KABUSHIKI KAISHA, Nagoya (JP)

(72) Inventor: Yuki YADA, Kuwana (JP)

(21) Appl. No.: 19/405,705

(22) Filed: Dec. 2, 2025

(30) Foreign Application Priority Data
Dec. 4, 2024 (JP) 2024-210995

(51) Int. Cl. G06F 3/12; G06F 11/07

(52) U.S. Cl. CPC G06F 3/1225; G06F 3/121; G06F 3/1234; G06F 3/1288; G06F 11/0733

(57) ABSTRACT

A communication device may receive an applying request from a server configured to store a first computer program related to the communication device. The applying request may request applying the first computer program to the communication device. The communication device may, in a case where the applying request is received from the server and the applying request includes first information, execute an applying process for applying the first computer program to the communication device. In a case where the applying request is received from the server and the applying request includes second information different from the first information, execution of the applying process may be suspended.

### REFERENCE TO RELATED APPLICATION

This application claims priority to Japanese Patent Application No. 2024-210995 filed on Dec. 4, 2024. The entire content of the priority application is incorporated herein by reference.

### BACKGROUND ART

A remote management system including a remote management server and a plurality of image forming devices is known. The remote management server sends an instruction for updating a firmware of an image forming device to the image forming device. The image forming device executes a process for updating the firmware when the image forming device receives the instruction from the remote management server.

### SUMMARY

The present teachings provide an art configured to apply a first computer program to a communication device at a suitable timing.

The disclosure discloses a communication device. The communication device may include a controller. The controller may be configured to receive an applying request from a server configured to store a first computer program related to the communication device. The applying request may request applying the first computer program to the communication device. The controller may be configured to, in a case where the applying request is received from the server and the applying request includes first information, execute an applying process for applying the first computer program to the communication device. In a case where the applying request is received from the server and the applying request includes second information different from the first information, execution of the applying process may be suspended.

The disclosure also discloses a server. The server may include a controller and a memory. The controller may be configured to, in a case where a first computer program is acquired, store the first computer program in the memory. The controller may be configured to, in a case where the first computer program is stored in the memory, send an applying request to a communication device. The applying request may request applying the first computer program to the communication device. The communication device may be configured to, in a case where the applying request is received from the server and the applying request includes first information, execute an applying process for applying the first computer program to the communication device. In a case where the applying request is received from the server and the applying request includes second information different from the first information, execution of the applying process may be suspended.

The disclosure also discloses a communication system including a communication device and a server. The server may include a first controller. The first controller may be configured to, in a case where a first computer program is acquired, store the first computer program in the memory. The first controller may be configured to, in a case where the first computer program is stored in the memory, send an applying request to the communication device. The applying request may request applying the first computer program to the communication device. The communication device may include a second controller. The second controller may be configured to receive the applying request from the server. The second controller may be configured to, in a case where the applying request is received from the server and the applying request includes first information, execute an applying process for applying the first computer program to the communication device. In a case where the applying request is received from the server and the applying request includes second information different from the first information, execution of the applying process may be suspended.

According to the above configuration, in the case where the communication device receives the applying request from the server and the applying request includes the first information, the communication device executes the applying process at the first timing. On the other hand, in the case where the applying request is received from the server and the applying request includes the second information, the execution of the applying process is suspended. Accordingly, the first computer program can be applied to the communication device at an appropriate timing.

A non-transitory computer-readable recording medium storing computer-readable instructions for the above-described communication device and a method executed by the above-described communication device are also novel and useful. A non-transitory computer-readable recording medium storing computer-readable instructions for the above-described server and a method executed by the above-described server are also novel and useful. Here, each of the above-mentioned computer-readable recording media may be a single medium, but may be plural media.

### BRIEF DESCRIPTION OF DRAWINGS

FIG. 1 illustrates a configuration of a communication system.

FIG. 2 illustrates a flowchart of a server process.

FIG. 3 illustrates a flowchart of a first firmware process.

FIG. 4 illustrates a flowchart of a second firmware process.

FIG. 5 illustrates an example of an update timing setting screen.

FIG. 6 illustrates a flowchart of a first firmware process.

FIG. 7 illustrates a flowchart of a second firmware process.

### DESCRIPTION

### First Embodiment

### Configuration of Communication System 2

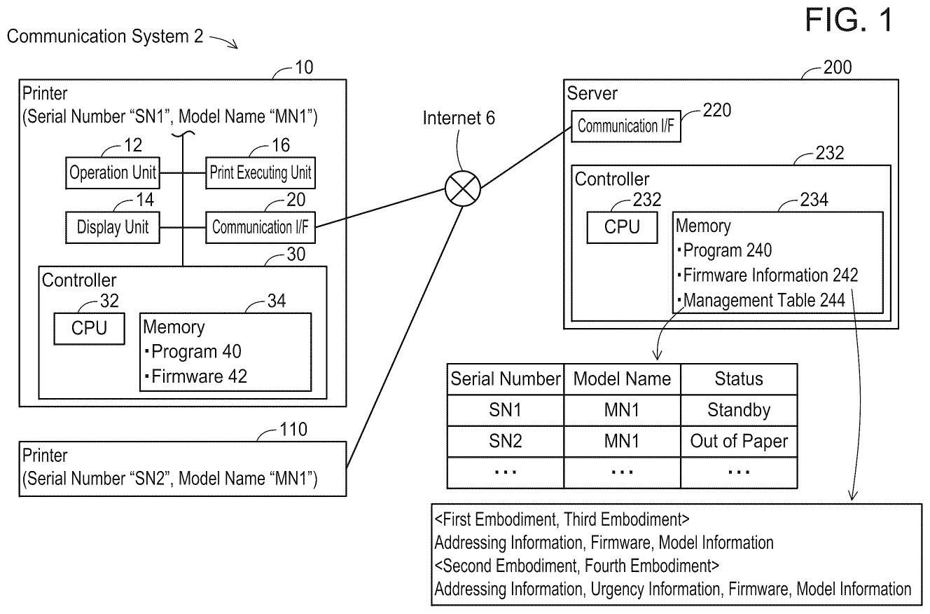

As illustrated in FIG. 1, a communication system 2 comprises printers 10, 110 and a server 200. The printers 10, 110 and the server 200 are connected to the Internet 6. The printers 10, 110 and the server 200 are configured to communicate with each other via the Internet 6.

### Printers 10, 110

The printer 10 is a peripheral device configured to execute a print function. The printer 10 is a peripheral device for a personal Computer (PC), for example. The printer 10 is further configured to execute a webserver function. The webserver function is a function of sending webpage data representing a webpage to an external device in response to the external device accessing a webserver in the printer 10. The printer 10 has a serial number “SN1” and a model name “MN1”. The serial number is an identification number assigned upon manufacture of a printer. The model name is a name indicative of a model of a printer.

The printer 10 comprises an operation unit 12, a display unit 14, a print executing unit 16, a communication interface 20, and a controller 30. Hereafter, an interface will be referred to as “I/F”.

The operation unit 12 is a user interface which allows a user to input various information to the printer 10. The operation unit 12 comprises a touch panel for displaying software key(s), hardware key(s), or both of them. The software key(s) are operational object(s). The hardware key(s) include for example button(s) and/or switch(es). The display unit 14 is a display or a panel configured to display various information. The panel may be a touch panel or may not be a touch panel. Also, the panel is for example a liquid crystal panel or an organic EL panel.

The print executing unit 16 comprises an electronic photo print engine, an inkjet print engine, or a thermal print engine. The inkjet print engine comprises a print head which ejects ink droplets. The electronic photo print engine comprises a photoreceptor and an exposure device which emits light to expose the photoreceptor. The thermal print engine comprises a print head which ejects heat with a heater. The communication I/F 20 is connected to the Internet 6.

The controller 30 comprises a CPU 32 and a memory 34. The memory 34 comprises a primary storage and an auxiliary storage. Although this is an example, the primary storage includes a RAM and cache memory. Although this is an example, the auxiliary storage may be a ROM, flash memory, Solid State Drive (SSD), Hard Disk Drive (HDD), or a combination thereof. The auxiliary storage of the memory 34 has a program 40 and a firmware 42 stored therein. The program 40 is a program configured to control basic operations of the printer 10. The firmware 42 is a program configured to control each hardware of the printer 10. The CPU 32 realizes various processes in accordance with a program loaded from the auxiliary storage onto the primary storage.

The printer 110 has the same configuration as the printer 10 except that the printer 110 has a serial number “SN2” and the model name “MN1”.

### Configuration of Server 200

The server 200 is disposed on the Internet 6 by a vendor of the printers 10, 110. The server 200 may be a single server or may be a collection of plural servers. The server 200 manages a plurality of printers including the printers 10, 110. The server 200 comprises a communication interface 220 and a controller 230. The communication I/F 220 is connected to the Internet 6.

The controller 230 comprises a CPU 232 and a memory 234. The memory 234 comprises a primary storage and an auxiliary storage. The auxiliary storage of the memory 234 has a program 240 stored therein. The CPU 232 realizes various processes in accordance with a program loaded from the auxiliary storage onto the primary storage.

The memory 234 further stores firmware information 242 and a management table 244. The firmware information 242 includes a firmware, addressing information, and model information. The firmware mentioned herein is a firmware for updates. The addressing information includes information to be addressed by the firmware. Although this is an example, the addressing information indicates that the firmware is a program which concerns security of a printer. Although this is an example, the case where the firmware is a program which concerns the security of the printer is a case where the firmware is a program which addresses issues of the webserver function such as web server function degradation. Although this is an example, the addressing information indicates that the firmware is a program for resolving a malfunction in the print function. Although this is an example, the addressing information indicates that the firmware is a program which concerns print quality. The model information indicates the model name of the printer corresponding to the firmware. The model information indicates one or more model names.

The management table 244 stores information of a plurality of printers. In the management table 244, a serial number, a model name, and status information are stored in association with each other. The status information is information indicating a status of a printer. Although this is an example, the status information is “Standby”, “Out of Paper”.

In the present embodiment, the server 200 periodically receives the serial number, the model name, and the status information from each of the printers 10, 110. Then, the server 200 updates the management table 244 by using the received serial number, model name, and status information.

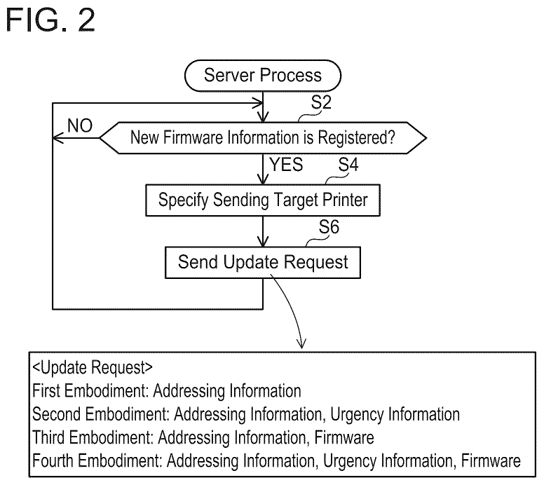

### Server Process; FIG. 2

With reference to FIG. 2, a server process executed by the CPU 232 of the server 200 will be described. Communication between the respective devices is performed via a communication I/F. Accordingly, in the following description, communication will be described without mentioning “via the I/F”.

In S2, the CPU 232 monitors for new firmware information to be registered in the memory 234. When the new firmware information is registered in the memory 234, the CPU 232 determines YES to S2, and proceeds to S4.

In S4, the CPU 232 specifies a printer to which an update request is to be sent, by using the model information in the firmware information registered in S2. Hereafter, the printer to which the update request is to be sent will be referred to as “sending target printer”. The update request is a signal for requesting for firmware update. The update request includes the addressing information in the firmware information registered in S2. The CPU 232 specifies one or more model names indicated by the model information within the firmware information. The CPU 232 specifies the serial number(s) stored in the management table 244 in association with the specified one or more model names. The CPU 232 specifies the one or more printers having the specified serial number(s) as the sending target printer. Although this is an example, when the model information within the update request includes the model name “MN1”, the CPU 32 specifies the printers 10, 110 as the sending target printers.

In S6, the CPU 232 sends the update request to the specified sending target printer(s). When S6 ends, the CPU 232 returns to S2.

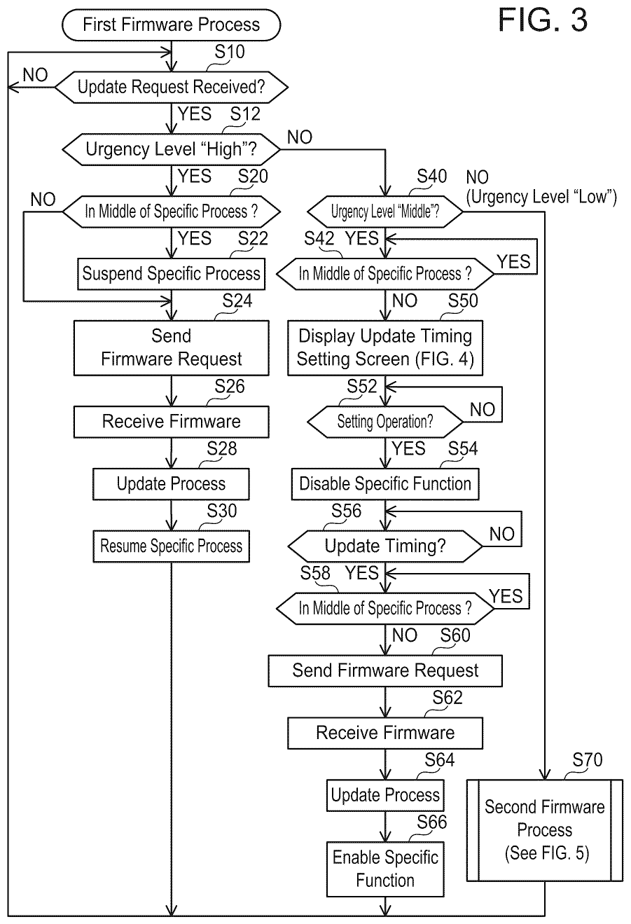

### First Firmware Process; FIG. 3

With reference to FIG. 3, a first firmware process executed by the CPU 32 of the printer 10 will be described.

In S10, the CPU 32 monitors receiving the update request from the server 200. When the CPU 32 receives the update request from the server 200, the CPU 32 determines YES to S10, and proceeds to S12. Hereafter, the update request received in S10 will be referred to as “target update request”.

In S12, the CPU 32 determines whether an urgency level corresponding to the addressing information within the target update request is “High” or not. When the urgency level corresponding to the addressing information is “High” (YES to S12), the CPU 32 proceeds to S20. Although this is an example, when the addressing information indicates that the firmware is a program which concerns security of the printer, the CPU 32 determines that the urgency level corresponding to the addressing information is “High”. Contrary to this, when the urgency level corresponding to the addressing information is not “High” (NO to S12), the CPU 32 proceeds to S40. Here, when the CPU 32 determines NO to S12, the CPU 32 determines to suspend execution of an update process to be described later.

In S20, the CPU 32 determines whether the printer 10 is in the middle of executing a specific process. Although this is an example, the specific process is a process executed in response to an instruction from the user. Although this is an example, the specific process is a print process. When the printer 10 is in the middle of executing the specific process (YES to S20), the CPU 32 proceeds to S22. Contrary to this, when the printer 10 is not in the middle of executing the specific process (NO to S20), the CPU 32 proceeds to S24.

In S22, the CPU 32 suspends the specific process.

In S24, the CPU 32 sends a firmware request to the server 200. The firmware request is a signal for requesting the server 200 to send a firmware for updates. The firmware request includes the serial number “SN1” and the model name “MN1”. When the server 200 receives the firmware request from the printer 10, the server 200 specifies the firmware information including the model name “MN1” within the firmware request. The server 200 sends the firmware in the specified firmware information as the firmware for updates to the printer 10.

In S26, the CPU 32 receives the firmware for updates from the server 200.

In S28, the CPU 32 executes the update process by using the firmware for updates received in S26. In the update process, the CPU 32 updates the firmware 42 in the memory 34 by using the firmware for updates.

As described above, when the urgency level is “High”, the CPU 32 executes the update process regardless of whether the printer 10 is in the middle of executing the specific process. According to the above configuration, the timing of executing the update process can be made earlier when the urgency level is “High”.

In S30, the CPU 32 resumes or restarts the specific process. Although this is an example, when the print process is suspended in S22, the CPU 32 resumes or restarts the print process in S30. When S30 ends, the CPU 32 returns to S10.

In S40, the CPU 32 determines whether the urgency level corresponding to the addressing information in the target update request is “Middle” or not. When the urgency level corresponding to the addressing information is “Middle” (YES to S40), the CPU 32 proceeds to S42. Although this is an example, when the addressing information indicates that the firmware is a program for resolving a malfunction in print quality, the CPU 32 determines that the urgency level corresponding to the addressing information is “Middle”. Contrary to this, when the urgency level corresponding to the addressing information is not “Middle” (NO to S40), the CPU 32 proceeds to S70. Here, the case where the urgency level corresponding to the addressing information is neither “High” nor “Middle” is when the urgency level for the addressing information is “Low”. Although this is an example, when the addressing information indicates that the firmware is a program which concerns the print quality, the CPU 32 determines that the urgency level corresponding to the addressing information is “Low”.

In S42, the CPU 32 determines whether the printer 10 is in the middle of executing the specific process. When the printer 10 is in the middle of executing the specific process (YES to S20), the CPU 32 stands by in S42. Contrary to this, when the printer 10 is not in the middle of executing the specific process (NO to S42), the CPU 32 proceeds to S50.

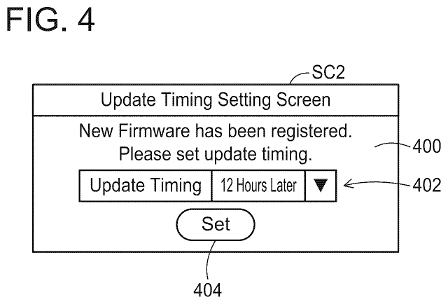

In S50, the CPU 32 displays an update timing setting screen SC2 on the display unit 14. As illustrated in FIG. 4, the update timing setting screen SC2 includes a first message 400, an update timing setting area 402, and a “Set” button 404. The first message 400 includes a message indicating that a new firmware has been registered and a message for prompting the user to set the update timing. The update timing setting area 402 is an area for setting the timing to update the firmware. The user can set a date and time when the update process is to be executed by operating on the update timing setting area 402. In the present embodiment, the user can select the update timing by operating a pull-down button in the update timing setting area 402. In a modification, the update timing setting area 402 may include an input area for the update timing. Although this is an example, the update timing is a date and time of update. According to the above configuration, the user can designate the update timing of the firmware. Accordingly, user convenience can be improved.

In S52 of FIG. 3, the CPU 32 monitors receiving a setting operation. The setting operation includes an operation of setting the update timing and an operation on the “Set” button 404. When the CPU 32 receives the setting operation, the CPU 32 determines YES to S52 and proceeds to S54.

In S54, the CPU 32 disables a specific function corresponding to the addressing information. Although this is an example, the addressing information indicates that the firmware is a program for resolving a malfunction in the print function, the print function is the specific function.

In S56, the CPU 32 monitors arrival of the update timing designated by the user. When the update timing arrives, the CPU 32 determines YES to S56, and proceeds to S58. A case in which the date and time when the update timing setting screen SC2 is displayed on the display unit 14 is “11:00, Nov. 10, 2024” and “12 Hours Later” is selected by the user will be assumed. The update timing in this case is “23:00, Nov. 10, 2024”. Then, when this timing “23:00, Nov. 10, 2024” arrives, the CPU 32 determines YES to S56.

S58 is the same as S42. When the CPU 32 determines NO to S58, the CPU 32 proceeds to S60.

S60, S62, S64 are the same as S24, S26, S28, respectively.

In S66, the CPU 32 enables the specific function which was disabled in S54. When S66 ends, the CPU 32 returns to S10.

When NO is determined to S40, the CPU 32 executes a second firmware process in S70. The second firmware process is a process for executing the update process when the urgency level corresponding to the addressing information is “Low”. When S70 ends, the CPU 32 returns to S10.

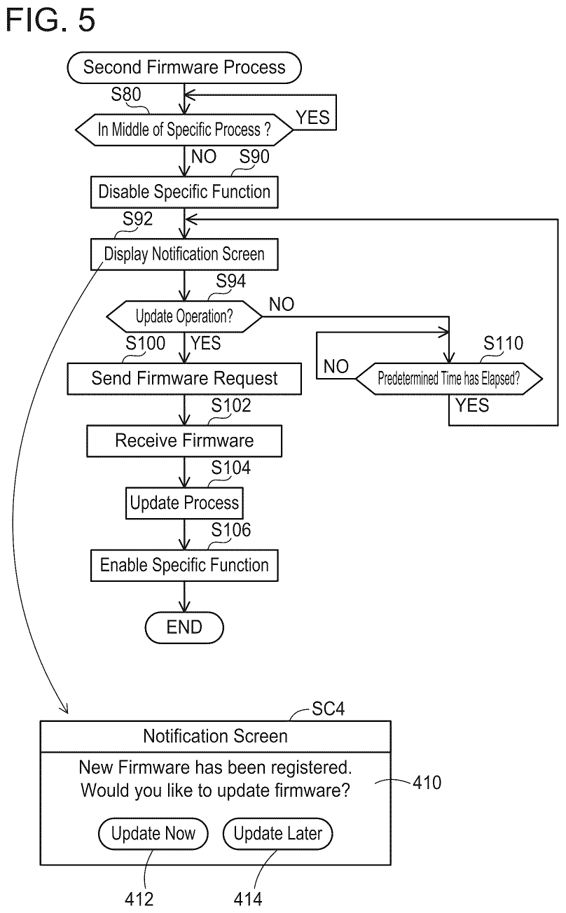

### Second Firmware Process; FIG. 5

With reference to FIG. 5, the second firmware process executed in S70 of FIG. 3 will be described.

S80 is the same as S42 of FIG. 3. When the CPU 32 determines NO to S80, the CPU 32 proceeds to S90.

S90 is the same as S54 of FIG. 3. Although this is an example, the addressing information indicates that the firmware is a program which concerns the print quality, a function included in the print function which addresses the print quality is the specific function.

In S92, the CPU 32 displays a notification screen SC4 on the display unit 14. The notification screen SC4 includes a second message 410, an “Update Now” button 412, and an “Update Later” button 414. The second message 410 includes a message indicating that a new firmware has been registered and a message for inquiring the user of whether to update the firmware or not.

In S94, the CPU 32 determines whether an update operation which is an operation on the “Update Now” button 412 has been received. When the update operation has been received (YES to S94), the CPU 32 proceeds to S100. Contrary to this, when the update operation is not received (NO to S94), the CPU 32 proceeds to S110. Here, the case where the update operation is not received is when an operation on the “Update Later” button 414 is received.

S100, S102, S104, S106 are the same as S60, S62, S64, S66 of FIG. 3, respectively. When S106 ends, the CPU 32 ends the processes of FIG. 5.

In S110, the CPU 32 monitors that a predetermined time elapses from when the operation on the “Update Later” button 414 was received. Although this is an example, the predetermined time is “One hour”. When the predetermined time elapses, the CPU 32 determines YES to S110, and returns to S92. As such, until the firmware is updated, each time the predetermined time elapses, the CPU 32 displays the notification screen SC4 on the display unit 14. According to the above configuration, the user can designate the timing for updating the firmware by adjusting the timing of executing the update operation. Accordingly, user convenience can be improved.

As mentioned above, when the urgency level for firmware update is “High” (YES to S12 of FIG. 3), the CPU 32 automatically executes the update process immediately after the CPU 32 has received the update request from the server 200 (S28). Contrary to this, when the urgency level for firmware update is “Middle” or “Low” (NO to S12), the CPU 32 suspends execution of the update process. In the present embodiment, the CPU 32 delays the timing for executing the update process relative to the timing for the CPU 32 to execute the update process when the urgency level for firmware update is “High”. Then, when the update timing designated by the user arrives after the execution of the update process has been suspended (YES to S56), or when the update operation is received (YES to S94 of FIG. 5), the CPU 32 executes the update process (S64, S104). According to such configuration, the firmware can be surely updated even after the execution of the update process has been suspended. Also, the user can designate the timing when the update process is to be executed. Accordingly, user convenience can be improved.

When the urgency level for firmware update is “Middle” or “Low” (NO to S12) and also the printer 10 is in the middle of executing the specific process (YES to S58, YES to S80 of FIG. 4), the CPU 32 executes the update process (S64, S104) in response to execution of the specific process being completed (NO to S58, NO to S80). The user may feel uncomfortable if the specific process is suspended. According to the above configuration, the user can be suppressed from feeling uncomfortable.

In the present embodiment, the update request does not include a firmware. Due to this, when the execution of the update process is suspended, the CPU 32 does not store the firmware for updates in the memory 34. Accordingly, storage capacity of the memory 34 can be effectively used.

### Effects by Present Embodiment

As described above, when the printer 10 receives the update request from the server 200 and also the urgency level corresponding to the addressing information is “High” (YES to S12 of FIG. 3), the printer 10 executes the update process (S28). Further, when the update request is received from the server 200 and also the urgency level corresponding to the addressing information is “Middle” or “Low” (NO to S12), execution of the update process is suspended. Accordingly, it is possible to update the firmware at a suitable timing.

### Correspondence Relationship

The printer 10 is an example for “communication device”. The firmware for updates is an example for “first program”. The update request is an example for “applying request”. The addressing information corresponding to the urgency level “High” is an example for “first information”. The update process is an example for “applying process”. The addressing information corresponding to the urgency level “Middle” or “Low” is an example for “second information”. The update timing setting screen SC2 of FIG. 4 and the notification screen SC4 of FIG. 5 are examples for “predetermined screen”. The firmware 42 in the memory 34 of the printer 10 is an example for “second computer program”.

S10 of FIG. 3 is an example for a process executed by “receive an applying request” of “communication device”. S28 of FIG. 3 is an example for a process executed by “execute an applying process” of “communication device”.

S2 of FIG. 3 is an example for a process executed by “store the first computer program in the memory” of “server”. S6 of FIG. 3 is an example for a process executed by “send an applying request” of “server”.

### Second Embodiment

A second embodiment will be described. As illustrated in FIG. 1, the firmware information 242 of the present embodiment includes addressing information, urgency information, a firmware, and model information. The urgency information is information indicating an urgency level. The urgency level is one of “High”, “Middle”, and “Low”. In the present embodiment, firmware information is registered in the memory 234 by an administrator of the server 200. That is, the urgency level is designated by the administrator. In a modification, the addressing information, the firmware, and the model information may be registered in the memory 234 by the administrator, and then the firmware information may be created by the server 200. In the present modification, the server 200 uses the registered addressing information to create the urgency information and create the firmware information including the addressing information, the urgency information, the firmware, and the model information, and stores the created firmware information in the memory 234.

As illustrated in FIG. 2, the update request of the present embodiment includes the addressing information and the urgency information that are included in the new firmware information.

In the present embodiment, the contents of the processes executed in S12 and S40 of FIG. 3 are different from the contents of the processes executed in S12 and S40 in the first embodiment.

In S12, the CPU 32 determines whether the urgency level indicated by the urgency information in the update request is “High” or not. When the urgency level indicated by the urgency information is “High” (YES to S12), the CPU 32 proceeds to S20. Contrary to this, when the urgency level indicated by the urgency information is not “High” (NO to S12), the CPU 32 proceeds to S40.

In S40, the CPU 32 determines whether the urgency level indicated by the urgency information in the received update request is “Middle” or not. When the urgency level indicated by the urgency information is “Middle” (YES to S40), the CPU 32 proceeds to S50. Contrary to this, when the urgency level indicated by the urgency information is not “Middle” (NO to S40), the CPU 32 proceeds to S70. Here, the case where the urgency level indicated by the urgency information is neither “High” nor “Middle” is when the urgency level indicated by the urgency information is “Low”.

As mentioned above, when the urgency level indicated by the urgency information is “High”, the CPU 32 executes the update process, while when the urgency level indicated by the urgency information is “Middle” or “Low”, the update process is suspended. That is, the urgency information indicating the urgency level “High” is information indicating that the update process is to be executed, and the urgency information indicating the urgency level “Middle” or “Low” is information indicating that execution of the update process is to be suspended. Also, the urgency information may be regarded as information indicating a timing when the update process is to be executed.

As mentioned above, the CPU 32 receives the urgency information from the server 200. Due to this, the CPU 32 may not execute a process for using the addressing information to specify the urgency level for firmware update. Accordingly, processing load on the CPU 32 of the printer 10 can be reduced.

### Correspondence Relationship

The urgency information indicating the urgency level “High” is an example for “information indicates that the applying process is to be executed”. The urgency information indicating the urgency level “Middle” or “Low” is an example for “information indicates that the execution of the applying process is to be suspended”.

### Third Embodiment

A third embodiment will be described. As illustrated in FIG. 1, firmware information 242 of the present embodiment includes addressing information, a firmware, and model information. As illustrated in FIG. 2, the update request of the present embodiment includes the addressing information and the firmware that are included in the new firmware information.

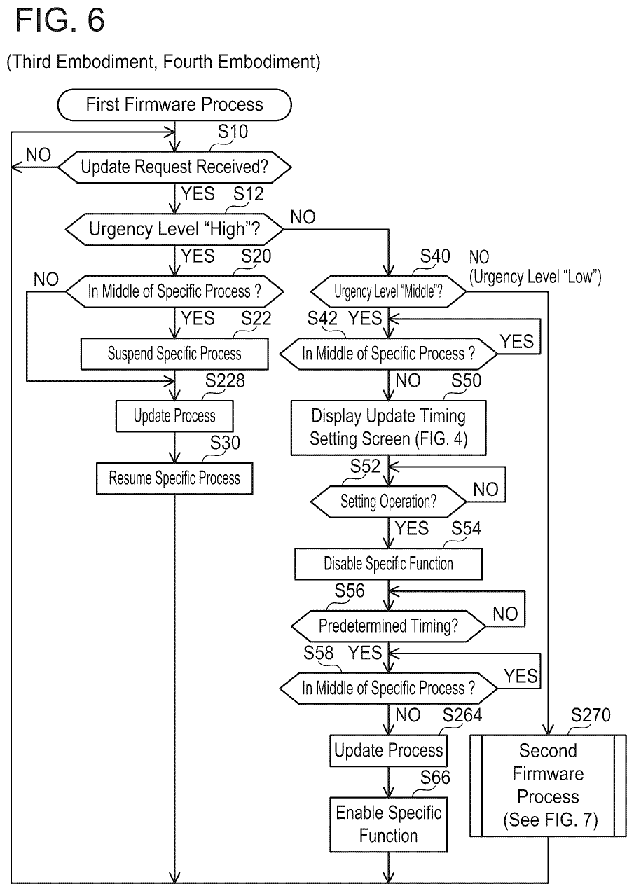

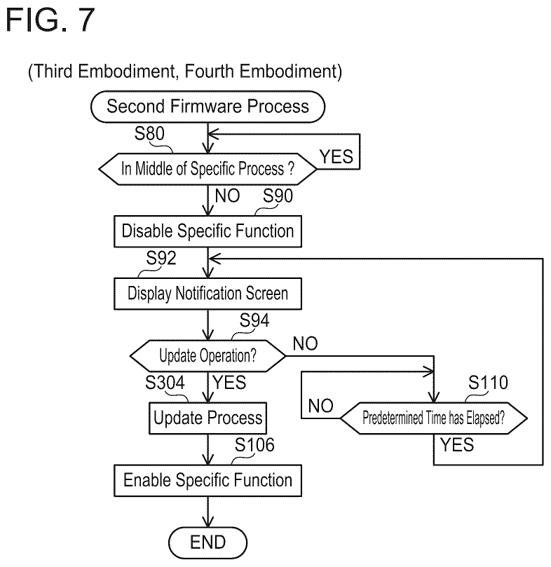

The CPU 32 of the printer 10 in the present embodiment executes a first firmware process of FIG. 6 and a second firmware process of FIG. 7, instead of the first firmware process of FIG. 3 and the second firmware process of FIG. 5, respectively.

### First Firmware Process; FIG. 6

With reference to FIG. 6, the first firmware process executed by the CPU 32 of the printer 10 will be described. Also, processes that are the same between the embodiments will be given the same step numbers, by which description thereof may be omitted.

When NO is determined to S20 or when S22 ends, the CPU 32 proceeds to S228. In S228, the CPU 32 executes the update process by using the firmware included in the received update request. In the update process, the CPU 32 updates the firmware 42 in the memory 34 by using the firmware included in the received update request.

When NO is determined to S40, the CPU 32 proceeds to S270. In S270, the CPU 32 executes the second firmware process. When S270 ends, the CPU 32 returns to S10.

When NO is determined to S58, the CPU 32 proceeds to S264. S264 is the same as S228.

### Second Firmware Process; FIG. 7

With reference to FIG. 7, the second firmware process executed in S270 of FIG. 6 will be described.

When YES is determined to S94, the CPU 32 proceeds to S304. S304 is the same as S228 of FIG. 6.

As mentioned above, in the present embodiment, the update request includes the firmware. Due to this, the CPU 32 does not send the firmware request to the server 200 before executing the update process. There is a case where, when the CPU 32 is sending the firmware request to the server 200, the printer 10 and the server 200 may have become incapable of communicating with each other. In this case, the update process fails. According to the above configuration, the possibility of the update process failing because the update request includes the firmware can be reduced. Also, because the firmware request is not sent to the server 200, the time required for the update process can be shortened.

### Fourth Embodiment

A fourth embodiment will be described. As illustrated in FIG. 1, firmware information 242 of the present embodiment includes addressing information, urgency information, a firmware, and model information. As illustrated in FIG. 2, the update request of the present embodiment includes the addressing information, the urgency information, and the firmware that are included in the new firmware information.

The CPU 32 of the present embodiment executes the first firmware process of FIG. 6 and the second firmware process of FIG. 7.

The contents of the processes executed in S12, S40 of FIG. 6 are respectively the same as the contents of the processes executed in S12, S40 of FIG. 3 in the second embodiment. Specifically, the CPU 32 uses the urgency information in the update request in S12 and S40.

(First Modification) The “communication device” is not limited to a printer, but may be a scanner, a copy machine, a multi-function peripheral, for example.

(Second Modification) In the above-mentioned first embodiment, the firmware 42 in the memory 34 of the printer 10 is updated by using the new firmware. In a modification, a firmware different from the firmware 42 in the memory 34 of the printer 10 may be installed on the printer 10.

In the present modification, the server 200 sends an install request to a sending target printer in S6 of FIG. 2. The install request is a signal for requesting to install a new firmware. The install request includes the addressing information.

The CPU 32 of the printer 10 monitors receiving of the install request from the server 200 in S10 of FIG. 3. Also, the CPU 32 executes an install process of installing a firmware for installing on the printer 10 in S28, S64, S104 of FIG. 5. Due to this, the firmware 42 and the new firmware are stored in the memory 34 of the printer 10.

In each of the second to fourth embodiments also, the server 200 and the printer 10 may execute processes which use the install request.

(Third Modification) In the first and second embodiments, when YES is determined to S12 of FIG. 3 and also the printer 10 is in the middle of executing the specific process, the CPU 32 may execute the processes from S24 in response to the execution of the specific process being completed. Also, in the third and fourth embodiments, when YES is determined to S12 of FIG. 6 and also the printer 10 is in the middle of executing the specific process, the CPU 32 may execute the processes from S228 in response to the execution of the specific process being completed.

(Fourth Modification) In the first and second embodiments, when the urgency level is not “High” (NO to S12 of FIG. 3), the CPU 32 of the printer 10 may not execute the update process. In the present modification, S40 to S70 of FIG. 3 and FIG. 4 may be omitted. In the third and fourth embodiments, when the urgency level is not “High” (NO to S12 of FIG. 6), the CPU 32 may not execute the update process. In the present modification, S40 to S58, S264, S66, S270 of FIG. 6 and FIG. 7 may be omitted. In the present modification, “in a case where a predetermined condition is satisfied after the execution of the applying process has been suspended, execute the applying process” may be omitted.

(Fifth Modification) In each of the embodiments, after YES has been determined to S56 of FIG. 3, FIG. 6, the processes same as S20, S22 may be executed instead of S58. Also, the processes same as S20, S22 may be executed instead of S80 in FIGS. 5 and 7.

(Sixth Modification) In each of the embodiments, update timing information indicating an update timing may be prestored in the memory 34 of the printer 10. In the present modification, S42, S50, S52 in FIGS. 3, 6 may be omitted. In the present modification, the CPU 32 of the printer 10 determines YES to S56 in FIGS. 3 and 6, when the update timing indicated by the update timing information in the memory 34 arrives. In the present modification, “display a predetermined screen on the display” may be omitted.

(Seventh Modification) When the CPU 32 determines NO to S42 in FIGS. 3 and 6, the CPU 32 may send update timing setting screen data to a terminal device. The terminal device is a terminal device such as a mobile phone, a PDA, a desktop PC, a laptop PC, a tablet PC, for example. The terminal device is a terminal device used by the user of the printer 10. When the terminal device receives the update timing setting screen data from the printer 10, the terminal device displays an update timing setting screen on a display unit of the terminal device. Then, when a setting operation is received by a user, the terminal device sends the update timing information to the printer 10. When the CPU 32 receives the update timing information from the terminal device, the CPU 32 stores the update timing information in the memory 34, and executes the processes from S54.

When S90 ends in FIGS. 5 and 7, the CPU 32 may send notification screen data to the terminal device. When the terminal device receives the notification screen data from the printer 10, the terminal device displays a notification screen on the display unit of the terminal device. Then, when the update operation is received by the user, the terminal device sends an update instruction to the printer 10. When the CPU 32 receives the update instruction from the terminal device, the CPU 32 executes the processes from S100. On the other hand, when the terminal device receives an operation on the “Update Later” button 414 from the user, the terminal device sends a standby instruction to the printer 10. When the CPU 32 receives the standby instruction from the terminal device, the CPU 32 executes the process of S110.

Here, one of the timing setting screen and the notification screen may be displayed on the printer 10, and the other may be displayed on the terminal device.

(Eighth Modification) In the first and second embodiments, when the urgency level is “Middle” (YES to S40 of FIG. 3), the CPU 32 may execute S70, that is, the second firmware process. Also, when the urgency level is “Low” (NO to S40 of FIG. 3), the CPU 32 may not execute the update process. In the third and fourth embodiments, when the urgency level is “Middle” (YES to S40 of FIG. 6), the CPU 32 may execute S270, that is, the second firmware process. Further, when the urgency level is “Low” (NO to S40 of FIG. 6), the CPU 32 may not execute the update process.

(Ninth Modification) In the first and second embodiments, when the urgency level is “Low” (NO to S40 of FIG. 3), the CPU 32 may not execute the update process. In the present modification, S70 of FIG. 3 and FIG. 4 may be omitted. In the third and fourth embodiments, when the urgency level is “Low” (NO to S40 of FIG. 6), the CPU 32 may not execute the update process. In the present modification, S270 of FIG. 6 and FIG. 7 may be omitted.

(Tenth Modification) The information indicating that the firmware is a program for resolving a malfunction in the print function may be an example for “first information”.

(Eleventh Modification) In the second and fourth embodiments, the firmware information and the update request may not include the addressing information. In the present modification, S54, S66 in FIGS. 3 and 6 and S90, S106 and FIGS. 5 and 7 may be omitted.

(Twelfth Modification) The firmware information 242 of FIG. 1 may comprise printer identification information for identifying a printer, instead of the model information. Although this is an example, the printer identification information is a serial number, a MAC address. In the present modification, the management table 244 may not include a model name.

(Thirteenth Modification) Although each of the processes of FIGS. 3 to 7 is realized by software, at least one of these processes may be realized by hardware such as logic circuitry. Although this is an example, the software is the program 40, 240.

What is claimed is:

1. A communication device comprising:
a controller,
wherein the controller is configured to:
receive an applying request from a server configured to store a first computer program related to the communication device, wherein the applying request requests applying the first computer program to the communication device; and
in a case where the applying request is received from the server and the applying request includes first information, execute an applying process for applying the first computer program to the communication device, wherein in a case where the applying request is received from the server and the applying request includes second information different from the first information, execution of the applying process is suspended.

2. The communication device according to claim 1, wherein in the case where the applying request is received from the server and the applying request includes the first information, the applying process is executed regardless of whether the communication device is in middle of executing a specific process.

3. The communication device according to claim 1, wherein the controller is further configured to:
in a case where a predetermined condition is satisfied after the execution of the applying process has been suspended, execute the applying process.

4. The communication device according to claim 3, wherein in a case where the applying request is received from the server, the applying request includes the second information, and the communication device is in middle of executing a specific process, the predetermined condition is satisfied in response to the execution of the specific process being completed.

5. The communication device according to claim 3, further comprising a display,
wherein the controller is further configured to:
in a case where the applying request is received from the server and the applying request includes the second information, display a predetermined screen on the display,
wherein the predetermined condition is satisfied in response to arrival of a timing which is designated by a user on the predetermined screen.

6. The communication device according to claim 5, wherein the predetermined screen is a screen for designating a date and time when the applying process is to be executed.

7. The communication device according to claim 5, wherein the communication device has a print function, and
the second information indicates that the first computer program is a program for resolving a malfunction of the print function.

8. The communication device according to claim 5, wherein the controller is configured to:
in a case where an operation for executing the applying process is not received on the predetermined screen, finish displaying the predetermined screen; and
in a case where a predetermined time elapses since the displaying of the predetermined screen has been finished, re-display the predetermined screen on the display,
wherein the predetermined condition is satisfied in response to the operation for executing the applying process being received on the predetermined screen.

9. The communication device according to claim 5, wherein the communication device has a print function, and
the second information indicates that the first computer program is a program which concerns print quality.

10. The communication device according to claim 1, wherein the first information indicates that the first computer program is a program which concerns security of the communication device, and
the controller is configured to, in the case where the applying request is received from the server and the applying request includes the first information, execute the applying process immediately after the applying request has been received from the server.

11. The communication device according to claim 1, wherein the first information indicates that the applying process is to be executed, and
the second information indicates that the execution of the applying process is to be suspended.

12. The communication device according to claim 1, further comprising a memory configured to store a second computer program,
wherein the applying process includes a process for updating the second computer program using the first computer program.

13. A server comprising:
a controller; and
a memory,
wherein the controller is configured to:
in a case where a first computer program is acquired, store the first computer program in the memory; and
in a case where the first computer program is stored in the memory, send an applying request to a communication device, wherein the applying request requests applying the first computer program to the communication device,
wherein the communication device is configured to, in a case where the applying request is received from the server and the applying request includes first information, execute an applying process for applying the first computer program to the communication device, and in a case where the applying request is received from the server and the applying request includes second information different from the first information, execution of the applying process is suspended.

14. The server according to claim 13, wherein the first information indicates that the applying process is to be executed, and
the second information indicates that the applying process is to be suspended.

15. The server according to claim 13, wherein the first information indicates that the first computer program is a program which concerns security of the communication device, and
the second information indicates that the first computer program is a program which concerns a print function of the communication device.

16. A non-transitory computer-readable recording medium storing computer-readable instructions for a communication device,
wherein the computer-readable instructions, when executed by the processor, cause the communication device to:
receive an applying request from a server configured to store a first computer program related to the communication device, wherein the applying request requests applying the first computer program to the communication device; and
in a case where the applying request is received from the server and the applying request includes first information, execute an applying process for applying the first computer program to the communication device, wherein in a case where the applying request is received from the server and the applying request includes second information different from the first information, execution of the applying process is suspended.

17. A non-transitory computer-readable recording medium storing computer-readable instructions for a server,
wherein the computer-readable instructions, when executed by the processor, cause the server to:
in a case where a first computer program is acquired, store the first computer program in a memory of the server; and
in a case where the first computer program is stored in the memory, send an applying request to a communication device, wherein the applying request requests applying the first computer program to the communication device,
wherein the communication device is configured to, in a case where the applying request is received from the server and the applying request includes first information, execute an applying process for applying the first computer program to the communication device, and in a case where the applying request is received from the server and the applying request includes second information different from the first information, execution of the applying process is suspended.

18. A communication system comprising:
a communication device; and
a server,
wherein the server comprises a first controller, and the first controller is configured to:
in a case where a first computer program is acquired, store the first computer program in the memory; and
in a case where the first computer program is stored in the memory, send an applying request to the communication device, wherein the applying request requests applying the first computer program to the communication device,
wherein the communication device comprises a second controller, and the second controller is configured to:
receive the applying request from the server; and
in a case where the applying request is received from the server and the applying request includes first information, execute an applying process for applying the first computer program to the communication device, wherein in a case where the applying request is received from the server and the applying request includes second information different from the first information, execution of the applying process is suspended.
